(19) United States
(12) Patent Application Publication
(10) Pub. No.: US 2013/0158201 A1
(43) Pub. Date: Jun. 20, 2013

(54) ACRYLIC COPOLYMER AND OPTICAL FILM INCLUDING THE SAME

(71) Applicants: Byoung-Il Kang, Daejeon (KR); Chang-Hun Han, Daejeon (KR)

(72) Inventors: Byoung-Il Kang, Daejeon (KR); Chang-Hun Han, Daejeon (KR)

(73) Assignee: LG Chem, Ltd., Seoul (KR)

(21) Appl. No.: 13/805,224

(22) PCT Filed: Jun. 14, 2011
(86) PCT No.: PCT/KR11/04341

§ 371 Date: Mar. 8, 2013

(30) Foreign Application Priority Data
Jun. 21, 2010 (KR) 10-2010-0058716

(51) Int. Cl. C08F 22/10

(52) U.S. Cl. CPC C08F 22/10
USPC 525/185; 526/326

(57) ABSTRACT

Provided are a heat resistant, high strength acrylic copolymer and an optical film including the same, and more particularly, an acrylic copolymer polymerized by including (1) an alkyl(meth)acrylate-based monomer excluding a tert-butyl(meth)acrylate-based monomer, (2) a (meth)acrylate-based monomer including an aliphatic ring and/or an aromatic ring, and (3) a tert-butyl(meth)acrylate-based monomer. The acrylic copolymer according to the present invention has excellent heat resistance as well as transparency being maintained. Also, the optical film including a compounding resin including the acrylic copolymer has excellent transparency, heat resistance, processability, adhesiveness, retardation properties, and durability.

### TECHNICAL FIELD

The present invention relates to an acrylic copolymer resin having excellent heat resistance and strength, a resin composition including the acrylic copolymer resin, an optical film including the resin composition and having excellent heat resistance, strength, and optical transparency, a polarizing plate including the optical film as a protective film, and a liquid crystal display including the polarizing plate.

### BACKGROUND ART

Display technologies using various devices replacing a conventional cathode ray tube, such as a plasma display panel (PDP) and a liquid crystal display (LCD), have been developed and have become commercially available on the basis of recent advancements in optical technology. The characteristics of polymer materials in such display devices have become highly advanced. For example, wide viewing angles, high contrast, prevention of changes in image color according to viewing angle, and uniformity of image display have become particularly important issues as liquid crystal displays have become lightweight and have been provided with large-sized picture areas as well as thin films.

Accordingly, various polymer films are used for a polarizing film, a polarizer protective film, a retardation film, a plastic substrate, or alight guiding plate, and liquid crystal displays having various modes have been developed by using twisted nematic (TN), super twisted nematic (STN), vertical alignment (VA), and in-plane switching (IPS) liquid crystal cells.

A polarizing plate generally has a structure in which a triacetyl cellulose film (hereinafter, referred to as a “TAC film”), as a protective film, is stacked on a polarizer generally having a structure having polyvinyl alcohol (PVA)-based molecular chains aligned in a predetermined direction and including an iodine-based compound or a dichroic polarizing material, or having a polyene structure formed by a dehydration reaction of a polyvinyl alcohol-based film or a dehydrochlorination reaction of a polyvinyl chloride (PVC) film by using a water-based adhesive formed of a polyvinyl alcohol-based aqueous solution.

Both of the polyvinyl alcohol-based film used as the polarizer and the TAC film used as the protective film for a polarizer may have insufficient resistance to heat and humidity. Accordingly, when a polarizing plate formed of the foregoing films is used over a prolonged period of time in a high-temperature or high-humidity environment, the polarizability thereof may degrade, the polarizer and the protective film may be separated or the optical properties thereof may deteriorate. Therefore, the foregoing polarizing plate may have various limitations in terms of the usage thereof. Thus, polarizing plates commercially developed to date may have insufficient reliability in terms of heat resistance and humidity resistance. Also, the TAC film has large changes in existing in-plane and thickness retardation values according to changes in an ambient temperature/humidity environment and in particular, the change of a retardation value with respect to incident light in an inclination direction may be large. When a polarizing plate, including a TAC film having the foregoing characteristics as a protective film, is applied to a liquid crystal display, image quality may deteriorate, as viewing angle characteristics may be changed according to changes in an ambient temperature/humidity environment. Further, the TAC film not only has a high dimensional change rate according to changes in an ambient temperature/humidity environment, but also has a relatively large photoelastic coefficient. Therefore, image quality may easily deteriorate due to the occurrence of local changes in retardation value characteristics after durability evaluation of heat and moisture resistance.

A methacrylic resin is a well-known material for compensating for various disadvantages of the TAC film. However, it is generally known that the methacrylic resin may be easily fractured or cracked and thus, limitations in transportability may occur during the production of the polarizing plate and productivity may be low.

In order to resolve such limitations, methods of blending other resins or a toughness conditioner with an acrylic resin (Japanese Patent Application Laid-Open Publication Nos. 2006-284881 and 2006-284882) or methods of stacking by coextruding other resins (Japanese Patent Application Laid-Open Publication Nos. 2006-243681, 2006-215463, 2006-215465, and 2007-017555) have been suggested. However, these methods may insufficiently reflect inherent heat resistance and transparency of the acrylic resin or may have a complex stacked structure.

### DISCLOSURE

### Technical Problem

An aspect of the present invention provides an acrylic copolymer resin having excellent heat resistance and strength as well as retained transparency.

Another aspect of the present invention provides a resin composition including the acrylic copolymer resin and a resin including an aromatic ring and/or an aliphatic ring in a main chain.

Another aspect of the present invention provides an optical film including the resin composition and having excellent heat resistance, strength, and optical transparency, a polarizing plate including the optical film as a protective film, and a liquid crystal display including the polarizing plate.

### Technical Solution

According to an aspect of the present invention, there is provided an acrylic copolymer polymerized by including: (1) an alkyl(meth)acrylate-based monomer excluding a tert-butyl(meth)acrylate-based monomer; (2) a (meth)acrylate-based monomer including an aliphatic ring and/or an aromatic ring; and (3) a tert-butyl(meth)acrylate-based monomer.

According to another aspect of the present invention, there is provided a resin composition containing the acrylic copolymer of the present invention and a resin including an aromatic ring and/or an aliphatic ring in a main chain mixed therein.

According to another aspect of the present invention, there is provided an optical film including the resin composition.

According to another aspect of the present invention, there is provided a polarizing plate including a polarizer and a protective film included on at least one side of the polarizer, wherein the protective film is the optical film of the present invention.

According to another aspect of the present invention, there is provided a liquid crystal display including the polarizing plate.

### Advantageous Effects

An acrylic copolymer according to the present invention has excellent heat resistance and strength as well as transparency being maintained. Also, an optical film including a resin composition including the acrylic copolymer has excellent transparency, heat resistance, strength, processability, adhesiveness, retardation properties, and durability.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates an example in which an optical film according to the present invention is used as a protective film in a liquid crystal display.

### BEST MODE

Hereinafter, the present invention will be described in detail.

An aspect of the present invention relates to an acrylic copolymer polymerized by including (1) an alkyl(meth)acrylate-based monomer excluding a tert-butyl(meth)acrylate-based monomer; (2) a (meth)acrylate-based monomer including an aliphatic ring and/or an aromatic ring; and (3) a tert-butyl(meth)acrylate-based monomer.

That is, the acrylic copolymer of the present invention includes a (meth)acrylate-based monomer including an aliphatic ring and/or an aromatic ring, and two or more alkyl(meth) acrylate-based monomers, and, at this time, at least one of the two or more alkyl(meth)acrylate-based monomers is essentially a tert-butyl(meth)acrylate-based monomer.

In the present specification, a copolymer resin including a monomer denotes that the monomer is polymerized to be included in the copolymer resin as a repeating unit.

Also, in the present specification, a meaning of an “(meth)acrylate-based monomer” includes an “acrylate-based monomer” or a “methacrylate-based monomer”.

The acryl-based copolymer may be a block copolymer or a random copolymer, but the type of acryl-based copolymer is not limited thereto.

In the alkyl(meth)acrylate-based monomer excluding a tert-butyl(meth)acrylate-based monomer of the acrylic copolymer resin, the alkyl(meth)acrylate-based monomer denotes both an alkyl acrylate-based monomer and an alkyl methacrylate-based monomer. An alkyl group of the alkyl(meth)acrylate-based monomer may have a carbon number of 1 to 10, for example, 1 to 4, and for example, may be a methyl group or an ethyl group. The alkyl(meth)acrylate-based monomer, for example, may be methyl methacrylate, but the alkyl(meth)acrylate-based monomer is not limited thereto.

In the acrylic copolymer resin, a content of the alkyl methacrylate-based monomer excluding a tert-butyl(meth)acrylate-based monomer may be within a range of 50 wt % to 98.9 wt % and for example, may be within a range of 50 wt % to 90 wt %. In the case that the content of the alkyl methacrylate-based monomer excluding a tert-butyl(meth)acrylate-based monomer is within the foregoing range, transparency thereof may be excellent as well as heat resistance thereof being maintained.

In the acrylic copolymer resin, the (meth)acrylate-based monomer including an aliphatic ring and/or an aromatic ring acts to improve heat resistance of the acrylic copolymer resin according to the present invention and for example, may be a cycloalkyl(meth)acrylate-based monomer or an aryl(meth)acrylate-based monomer.

A cycloalkyl group of the cycloalkyl(meth)acrylate-based monomer has a carbon number of 4 to 12, may have a carbon number of 5 to 8, and for example, may be a cyclohexyl group. Also, an aryl group of the aryl(meth)acrylate-based monomer may have a carbon number of 6 to 12 and for example, may be a phenyl group.

Specific examples of the (meth)acrylate-based monomer including an aliphatic ring and/or an aromatic ring may be cyclopentyl methacrylate, cyclohexyl methacrylate, benzyl methacrylate, cyclohexyl acrylate, 2-phenoxyethyl acrylate, 3,3,5-trimethylcyclohexyl methacrylate, 4-t-butylcyclohexyl methacrylate, 3-cyclohexylpropyl methacrylate, phenyl methacrylate, 4-t-butylphenyl methacrylate, 4-methoxyphenyl methacrylate, 1-phenylethyl methacrylate, 2-phenylethyl acrylate, 2-phenylethyl methacrylate, 2-phenoxyethyl methacrylate, and 2-naphthyl methacrylate. The (meth)acrylate-based monomer including an aliphatic ring and/or an aromatic ring may be cyclohexyl methacrylate or phenyl methacrylate, but the (meth)acrylate-based monomer including an aliphatic ring and/or an aromatic ring is not limited thereto.

In the acrylic copolymer resin, a content of the (meth)acrylate-based monomer including an aliphatic ring and/or an aromatic ring may be within a range of 1 wt % to 49.9 wt % and for example, may be within a range of 1 wt % to 30 wt %. In the case that the content of the (meth)acrylate-based monomer including an aliphatic ring and/or an aromatic ring is within the foregoing range, heat resistance thereof may be sufficiently secured.

In the acrylic copolymer resin, the tert-butyl (meth) acrylate-based monomer acts to allow the copolymer of the present invention to exhibit higher heat resistance and strength.

The tert-butyl (meth) acrylate-based monomer may be included in an amount ranging from 0.1 wt % to 10 wt %.

That is, the acrylic copolymer resin includes 1 wt % to 49.9 wt % of the (meth) acrylate-based monomer including an aliphatic ring and/or an aromatic ring and 50.1 wt % to 99 wt % of the alkyl(meth) acrylate monomer-based monomer, and 0.1 wt % to 10 wt % of the alkyl(meth) acrylate-based monomer is a tert-butyl (meth)acrylate-based monomer.

Also, a weight-average molecular weight of the acrylic copolymer resin may be within a range of 50,000 to 150,000 in view of heat resistance, processability, and productivity.

The acrylic copolymer resin may have a glass transition temperature (Tg) of 120° C. or more, for example, 130° C. or more. The glass transition temperature of the acrylic copolymer resin is not particularly limited, but the glass transition temperature of the acrylic copolymer resin may be 200° C. or less.

A second aspect of the present invention relates to a resin composition containing the acrylic copolymer of the first aspect of the present invention and a resin including an aromatic ring and/or an aliphatic ring in a main chain mixed therein.

In the resin composition, examples of the resin including an aromatic ring and/or an aliphatic ring in a main chain may be a polycarbonate-based resin, a polyarylate-based resin, a polynaphthalene-based resin, and polynorbornene-based resin. For example, the resin including an aromatic ring and/or an aliphatic ring in a main chain may be a polycarbonate-based resin, but the resin including an aromatic ring and/or an aliphatic ring in a main chain is not limited thereto.

The resin composition may include 90 wt % to 99.9 wt % of the acrylic copolymer resin and 0.1 wt % to 10 wt % of the resin including an aromatic ring and/or an aliphatic ring in a main chain based on a total weight of the composition, and for example, may be include 95 wt % to 99.5 wt % of the acrylic copolymer resin and 0.5 wt % to 5 wt % of the resin including an aromatic ring and/or an aliphatic ring in a main chain.

The resin composition may be prepared by blending the acrylic copolymer resin and the resin including an aromatic ring and/or an aliphatic ring in a main chain according to a method well-known in the art, such as a compounding method, and may include additives well-known in the art, such as a colorant, a flame retardant, a reinforcing agent, a filler, an ultraviolet (UV) stabilizer, and an antioxidant in an amount ranging from 0.001 wt % to 30 wt % based on the total weight of the resin composition.

A glass transition temperature of the resin composition may be 110° C. or more, and for example, may be 120° C. or more. The glass transition temperature of the resin composition is not particularly limited, but the glass transition temperature of the resin composition may be 200° C. or less.

Also, a weight-average molecular weight of the resin composition may be within a range of 50,000 to 150,000 in terms of heat resistance, sufficient processability, and productivity.

A third aspect of the present invention relates to an optical film including the foregoing resin composition.

The optical film according to the present invention may have different retardation values according to the content of the resin including an aromatic ring and/or an aliphatic ring in a main chain, and, as a result, may be used as a polarizer protective film.

In the case that the content of the resin including an aromatic ring and/or an aliphatic ring in a main chain is within a range of 0.1 wt % to 5 wt %, for example, 1 wt % to 3 wt %, an in-plane retardation value (Rᵢₙ) of the optical film is within a range of 0 nm to 10 nm, may be within a range of 0 nm to 5 nm, and for example, may be about 0 nm, and a thickness retardation value (Rₜₕ) thereof is within a range of −5 nm to 5 nm, may be within a range of 0 nm to 5 nm, and for example, may be about 0 nm. In this case, the optical film according to the present invention may be used as a polarizer protective film.

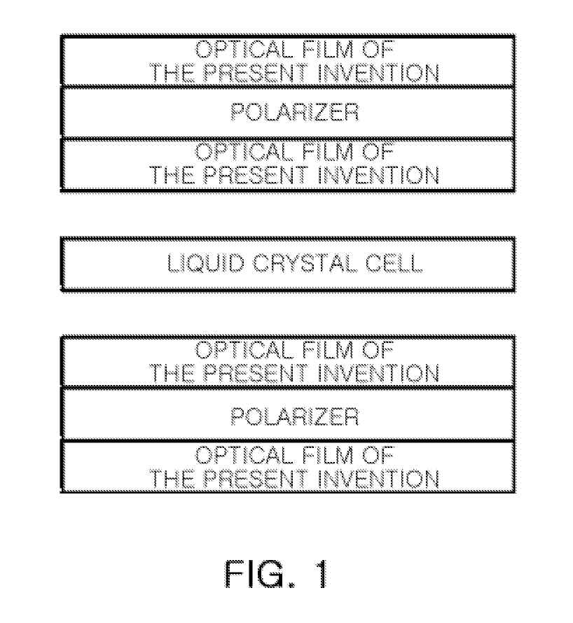

An example, in which the optical film according to the present invention is used as a protective film, is shown in FIG. 1. In FIG. 1, all protective films included in both sides of two polarizing plates are the optical films according to the present invention, but a typical protective film may be used as at least one of the protective films.

The resin composition may be prepared as a film according to a method well-known in the art, such as a solution cast method or an extrusion method, and the solution cast method may be used among these methods.

Uniaxial or biaxial stretching of the film thus prepared may be further included and the optical film may be prepared by adding a conditioner in some cases.

When the film is uniaxially or biaxially stretched, machine direction (MD) stretching or transverse direction (TD) stretching may be respectively performed, or both may be performed in the stretching process. In the case that both machine direction stretching and transverse direction stretching are performed, any stretching is first performed and then the further stretching may be performed, or both stretching processes may be performed simultaneously. The stretching processes may be performed in a single operation, and may also be performed through multiple operations. Stretching by means of the speed difference between rolls may be performed with respect to the machine direction stretching and a tenter may be used with respect to the transverse direction stretching. A rail start angle of the tenter is generally set to within 10 degrees to prevent a bowing phenomenon generated during transverse direction stretching and regularly control an angle of an optical axis. The effect of preventing the bowing phenomenon may be obtained when the transverse direction stretching is performed through multiple operations.

The stretching process may be performed within a temperature range of (Tg−20° C.) to (Tg+30° C.) where Tg denotes the glass transition temperature of the resin composition. The glass transition temperature indicates the temperature range starting from a temperature at which a storage modulus starts to decrease and becomes smaller than a loss modulus to a temperature at which the orientation of a polymer chain is relaxed and disappears. The glass transition temperature may be measured by a differential scanning calorimeter (DSC). The temperature during the stretching process may be, for example, the glass transition temperature of the film.

A stretching operation may be performed in a stretching speed range of 1 mm/min to 100 mm/min with respect to a small stretching machine (universal testing machine, Zwick 2010) and may be performed in a stretching speed range of 0.1 m/min to 2 m/min with respect to a pilot stretching machine. The film may be stretched by applying a stretching ratio of 5% to 300% thereto.

Retardation properties of the optical film according to the present invention may be adjusted through uniaxial or biaxial stretching by means of the foregoing method.

In the optical film thus prepared, an in-plane retardation value (Rᵢₙ) expressed as the following Equation 1 is within a range of 0 nm to 10 nm, may be within a range of 0 nm to 5 nm, and for example, may be about 0 nm, and a thickness retardation value (Rₜₕ) expressed as the following Equation 2 is within a range of −5 nm to 5 nm, may be within a range of 0 nm to 5 nm, and for example, may be about 0 nm. In this case, the optical film according to the present invention may be used as a polarizer protective film.

Rᵢₙ=(nₓ−n_{y})×d [Equation 1]

Rₜₕ=(n_{z}−n_{y})×d [Equation 2]

Where nₓ is an in-plane refractive index of the film in a direction having the largest refractive index, n_{y} is an in-plane refractive index of the film in a direction perpendicular to the nₓ direction, n_{z} is a thickness refractive index, and d is a thickness of the film.

The optical film according to the present invention may have a photoelastic coefficient lower than that of a typical triacetyl cellulose (TAC) film. The photoelastic coefficient of the optical film according to the present invention is 10 or less, may be 8 or less, may be within a range of 0.1 or more to 7 or less, and for example, may be within a range of 0.5 or more to 6 or less.

Brittleness of the optical film according to the present invention may be measured by measuring a height from which a steel ball having a diameter of 15.9 mm and a weight of 16.3 g is dropped on a test film to make an indentation in the film, and, with respect to the optical film according to the present invention, the height may be 600 mm or more and, for example, may be 650 mm or more.

A haze value of the optical film according to the present invention is 1% or less, may be 0.5% or less, and for example, may be 0.1% or less.

A fourth aspect of the present invention relates to a polarizing plate including a polarizer and a protective film included on at least one side of the polarizer, in which the protective film is the optical film of the present invention.

A fifth aspect of the present invention relates to a liquid crystal display including the polarizing plate. The liquid crystal display may be a vertical alignment (VA) mode or twisted nematic (TN) mode liquid crystal display.

The liquid crystal display including the polarizing plate according to the present invention will be described in more detail below.

In a liquid crystal display including a liquid crystal cell, and a first polarizing plate and a second polarizing plate respectively included in both sides of the liquid crystal cell, the optical film of the present invention may be included as a protective film on one side or both sides of the first polarizing plate and the second polarizing plate.

In the case that the optical film of the present invention is only included on one side of the polarizer, a protective film well known in the art may be included in the other side thereof.

A film formed of polyvinyl alcohol (PVA) containing iodine or a dichroic dye may be used as the polarizer. The polarizer may be prepared by dyeing a PVA film with iodine or a dichroic dye, but a method of preparing the polarizer is not particularly limited. In the present specification, the polarizer denotes a state in which a protective film is not included, and the polarizing plate denotes a state in which the polarizer and the protective film are included.

In an integrated polarizing plate of the present invention, the protective film and the polarizer may be laminated by a method well-known in the art.

For example, the protective film and the polarizer may be laminated by a bonding method using glue. That is, a surface of the protective film or a polyvinyl alcohol (PVA) film as the polarizer (polarizing layer) is first coated with glue by using a roll coater, a gravure coater, a bar coater, a knife coater, or a capillary coater. Before the glue is completely dried, the polarizer protective film and the polarizer are laminated by hot pressing with a laminating roll or by pressing at room temperature. When a hot-melt type glue is used, a hot-pressing roll must be used.

The glue usable during the lamination of the polarizer protective film and the polarizer may include a one-component type or two-component type PVA glue, a polyurethane-based glue, an epoxy-based glue, a styrene butadiene rubber (SBR)-based glue, or a hot-melt type glue. However, the glue is not limited thereto. When the polyurethane-based glue is used, a polyurethane-based glue prepared by using an aliphatic isocyanate-based compound, not yellowed by exposure to light, may be used. When a one-component type or two-component type glue for a dry laminate or a glue having relatively low reactivity with isocyanate and a hydroxy group is used, a solution-type glue diluted with an acetate-based solvent, a ketone-based solvent, an ether-based solvent, or an aromatic-based solvent may be used. At this time, viscosity of the glue may be a low value of 5,000 cps or less. The foregoing glues may have a degree of optical transmission of 90% or more in a wavelength range of 400 nm to 800 nm as well as excellent storage stability.

An adhesive may also be used when the adhesive exhibits sufficient adhesion. The adhesive, of which mechanical strength may be improved to a level of the glue through the occurrence of sufficient curing by means of heat or ultraviolet rays after the lamination, may be used and may have adhesion to such a degree that delamination is not generated without destroying any one of both films having the adhesive because its interfacial bond strength is also high.

Particular examples of the usable adhesive may be a natural rubber having excellent optical transparency, a synthetic rubber or an elastomer, a vinyl chloride/vinyl acetate copolymer, polyvinylalkylether, polyacrylate, or a modified polyolefin-based adhesive, and a curable adhesive to which a hardener such as isocyanate is added.

Also, the present invention provides a liquid crystal display including the integrated polarizing plate.

Hereinafter, preferred examples are provided to allow for a clearer understanding of the present invention. However, the following examples are merely presented to exemplify the present invention, and the scope of the present invention is not limited thereto.

### Mode for Invention

### EXAMPLES

A method of evaluating physical properties in examples of the present invention is as below.

1. Weight-Average Molecular Weight: the prepared resin was dissolved in tetrahydrofuran and measured by using gel permeation chromatography (GPC).

2. Glass Transition Temperature (Tg): measured by using a differential scanning calorimeter (DSC) by TA instruments.

3. Retardation value (Rᵢₙ/Rₜₕ): measured by using an AxoScan by Axometrics, Inc., after stretching at a glass transition temperature of a film.

4. Haze value (transparency): measured by using a HM-150 hazemeter by Murakami Color Research Laboratory.

### Example 1

An acrylic copolymer resin was prepared from 89 parts by weight of methyl methacrylate, 10 parts by weight of phenyl methacrylate, and 1 part by weight of tert-butyl methacrylate (tBMA). As a result of measuring a glass transition temperature and a molecular weight of the prepared resin, resin having a glass transition temperature of 122° C. and a molecular weight of 115,000 was obtained. A final resin composition was prepared through compounding 98 parts by weight of the resin with 2 parts by weight of polycarbonate. A film was prepared from the resin composition by using a solution cast method, and stretching was then performed at the glass transition temperature and retardation values of the film were measured. The resulting in-plane and thickness retardation values were 1.5 and −0.9, respectively.

### Example 2

An acrylic copolymer resin was prepared from 87 parts by weight of methyl methacrylate, 10 parts by weight of phenyl methacrylate, and 3 parts by weight of tert-butyl methacrylate (tBMA). As a result of measuring a glass transition temperature and a molecular weight of the prepared resin, resin having a glass transition temperature of 128° C. and a molecular weight of 110,000 was obtained. A final resin composition was prepared through compounding 98 parts by weight of the resin with 2 parts by weight of polycarbonate. A film was prepared from the resin composition by using a solution cast method, and stretching was then performed at the glass transition temperature and retardation values of the film were measured. The resulting in-plane and thickness retardation values were 1.6 and −0.9, respectively.

### Example 3

An acrylic copolymer resin was prepared from 85 parts by weight of methyl methacrylate, 10 parts by weight of phenyl methacrylate, and 5 parts by weight of tert-butyl methacrylate (tBMA). As a result of measuring a glass transition temperature and a molecular weight of the prepared resin, resin having a glass transition temperature of 131t and a molecular weight of 110,000 was obtained. A final compounding resin was prepared through compounding 98 parts by weight of the resin with 2 parts by weight of polycarbonate. A film was prepared from the compounding resin by using a solution cast method, and stretching was then performed at the glass transition temperature and retardation values of the film were measured. The resulting in-plane and thickness retardation values were 1.3 and −1.6, respectively.

### Example 4

An acrylic copolymer resin was prepared from 80 parts by weight of methyl methacrylate, 10 parts by weight of phenyl methacrylate, and 10 parts by weight of tert-butyl methacrylate (tBMA). As a result of measuring a glass transition temperature and a molecular weight of the prepared resin, a resin having a glass transition temperature of 136° C. and a molecular weight of 110,000 was obtained. A final compounding resin was prepared through compounding 98 parts by weight of the resin with 2 parts by weight of polycarbonate. A film was prepared from the compounding resin by using a solution cast method, and stretching was then performed at the glass transition temperature and retardation values of the film were measured. The resulting in-plane and thickness retardation values were 1.8 and −1.5, respectively.

### Comparative Example 1

An acrylic copolymer resin was prepared from 90 parts by weight of methyl methacrylate and 10 parts by weight of phenyl methacrylate. As a result of measuring a glass transition temperature and a molecular weight of the prepared resin, a resin having a glass transition temperature of 118° C. and a molecular weight of 100,000 was obtained. A final compounding resin was prepared through compounding 98 parts by weight of the resin with 2 parts by weight of polycarbonate. A film was prepared from the compounding resin by using a solution cast method, and stretching was then performed at the glass transition temperature and retardation values of the film were measured. The resulting in-plane and thickness retardation values were 1.4 and −0.9, respectively.

The results of Examples and Comparative Example are summarized in the following Tables 1 and 2.

TABLE 1

| | Monomer (wt %) | | | | |
|---|---|---|---|---|---|
| | MMA | PhMA | TBMA | Tg (° C.) | Mw |
| Example 1 | 89 | 10 | 1 | 122 | 115000 |
| Example 2 | 87 | 10 | 3 | 128 | 100000 |
| Example 3 | 85 | 10 | 5 | 131 | 110000 |
| Example 4 | 80 | 10 | 10 | 136 | 110000 |
| Comparative | 90 | 10 | — | 118 | 100000 |
| Example 1 | | | | | |

MMA: methyl methacrylate
PhMA: phenyl methacrylate
TBMA: tert-butyl methacrylate

As illustrated in Table 1, the acrylic copolymers of the present invention prepared in Examples 1 to 4 had glass transition temperatures higher than that of Comparative Example, and thus, it may be confirmed that the acrylic copolymers prepared in Examples 1 to 4 had excellent heat resistance.

TABLE 2

| | | | | Compounding | | | | |
|---|---|---|---|---|---|---|---|---|
| | Monomer (wt %) | | | (parts by weight) | | Transparency | Rᵢₙ | Rₜₕ |
| | MMA | PhMA | TBMA | MMA-PhMA-TBMA | PC | Haze (%) | (nm) | (nm) |
| Example 1 | 89 | 10 | 1 | 98 | 2 | ? | 1.5 | −0.9 |
| Example 2 | 87 | 10 | 3 | 98 | 2 | ? | 1.6 | −0.9 |
| Example 3 | 85 | 10 | 5 | 98 | 2 | ? | 1.3 | −1.6 |
| Example 4 | 80 | 10 | 10 | 98 | 2 | ? | 1.8 | −1.5 |
| Comparative | 90 | 10 | — | 98 | 2 | ? | 1.4 | 0.9 |
| Example 1 | | | | | | | | |

PC: Polycarbonate

As illustrated in Table 1, it may be confirmed that the optical films of the present invention prepared in Examples 1 to 4 had excellent transparency and retardation values in an appropriate range.

### Experimental Example 1

### Falling Ball Test-Strength Evaluation

Falling ball tests were performed in order to measure strengths of the films prepared in Examples 1 to 4 and Comparative Example 1. The strength of each film was measured by measuring a height from which a steel ball having a diameter of 15.9 mm and a weight of 16.3 g was dropped on the film to make an indentation in the film. The results of the measured heights are presented in the following Table 3.

TABLE 3

| | Exam- | Exam- | Exam- | Exam- | Comparative |
|---|---|---|---|---|---|
| | ple 1 | ple 2 | ple 3 | ple 4 | Example 1 |
| Height for | 650 | 640 | 670 | 630 | 540 |
| making an | | | | | |
| indentation in | | | | | |
| the film (mm) | | | | | |

While the present invention has been shown and described in connection with the exemplary embodiments, it will be apparent to those skilled in the art that modifications and variations can be made without departing from the spirit and scope of the invention as defined by the appended claims.

1. An acrylic copolymer polymerized by comprising:
(1) an alkyl(meth)acrylate-based monomer excluding a tert-butyl(meth)acrylate-based monomer;
(2) a (meth)acrylate-based monomer including an aliphatic ring, an aromatic ring, or a combination thereof; and
(3) a tert-butyl(meth)acrylate-based monomer.

2. The acrylic copolymer of claim 1, wherein an alkyl group of the alkyl(meth)acrylate-based monomer excluding a tert-butyl(meth)acrylate-based monomer has a carbon number of 1 to 10.

3. The acrylic copolymer of claim 1, wherein the alkyl(meth)acrylate-based monomer excluding a tert-butyl(meth)acrylate-based monomer is methyl (meth)acrylate.

4. The acrylic copolymer of claim 1, wherein the (meth)acrylate-based monomer including an aliphatic ring, an aromatic ring, or a combination thereof is a cycloalkyl(meth)acrylate-based monomer or an aryl(meth)acrylate-based monomer.

5. The acrylic copolymer of claim 4, wherein a cycloalkyl group of the cycloalkyl(meth)acrylate-based monomer has a carbon number of 4 to 12 and an aryl group of the aryl(meth)acrylate-based monomer has a carbon number of 6 to 12.

6. The acrylic copolymer of claim 1, wherein the (meth)acrylate-based monomer including an aliphatic ring, an aromatic ring, or a combination thereof is one or more selected from the group consisting of cyclopentyl methacrylate, cyclohexyl methacrylate, benzyl methacrylate, cyclohexyl acrylate, 2-phenoxyethyl acrylate, 3,3,5-trimethylcyclohexyl methacrylate, 4-t-butylcyclohexyl methacrylate, 3-cyclohexylpropyl methacrylate, phenyl methacrylate, 4-t-butylphenyl methacrylate, 4-methoxyphenyl methacrylate, 1-phenylethyl methacrylate, 2-phenylethyl acrylate, 2-phenylethyl methacrylate, 2-phenoxyethyl methacrylate, and 2-naphthyl methacrylate.

7. The acrylic copolymer of claim 1, wherein the acrylic copolymer is polymerized by comprising:
50 wt % to 98.9 wt % of the alkyl(meth)acrylate-based monomer excluding a tert-butyl(meth)acrylate-based monomer;
1 wt % to 49.9 wt % of the (meth)acrylate-based monomer including an aliphatic ring, an aromatic ring, or a combination thereof; and
0.1 wt % to 10 wt % of the tert-butyl(meth)acrylate-based monomer.

8. The acrylic copolymer of claim 1, wherein a glass transition temperature (Tg) of the acrylic copolymer is 120° C. or more.

9. The acrylic copolymer of claim 1, wherein a weight-average molecular weight of the acrylic copolymer is within a range of 50,000 to 150,000.

10. A resin composition containing the acrylic copolymer of claim 1, and a resin comprising an aromatic ring, an aliphatic ring, or a combination thereof in a main chain mixed therein.

11. The resin composition of claim 10, wherein the resin comprising an aromatic ring, an aliphatic ring, or a combination thereof in a main chain is polycarbonate.

12. The resin composition of claim 11, wherein the resin composition comprises 90 wt % to 99.9 wt % of the acrylic copolymer and 0.1 wt % to 10 wt % of the polycarbonate based on a total weight of the resin composition.

13. An optical film comprising the resin composition of claim 10.

14. The optical film of claim 13, wherein the optical film is a polarizer protective film.

15. A polarizing plate comprising a polarizer and a protective film included on at least one side of the polarizer, wherein the protective film is the optical film of claim 14.

16. The optical film of claim 13, wherein the optical film has an in-plane retardation value (Rᵢₙ) expressed as the following Equation 1 in a range of 0 nm to 10 nm and a thickness retardation value (Rₜₕ) expressed as the following Equation 2 in a range of −5 nm to 5 nm:
Rᵢₙ=(nₓ−n_{y})×d [Equation 1]
Rₜₕ=(n_{z}−n_{y})×d [Equation 2]
where nₓ is an in-plane refractive index of the film in a direction having the largest refractive index, n_{y} is an in-plane refractive index of the film in a direction perpendicular to the nₓ direction, n_{z} is a thickness refractive index, and d is a thickness of the film.

17. A liquid crystal display comprising the polarizing plate of claim 15.

18. The liquid crystal display of claim 17, wherein the liquid crystal display is a vertical alignment (VA) mode liquid crystal display.
